(19) United States
(12) Patent Application Publication
(10) Pub. No.: US 2026/0178672 A1
(43) Pub. Date: Jun. 25, 2026

(54) CUSTOM SUGGESTIONS OF BLOCKS FOR A USER OF A BLOCK-BASED WORKSPACE

(71) Applicant: Notion Labs, Inc., San Francisco, CA (US)

(72) Inventors: Dong Jae Chung, Belmont, CA (US); Avery Laura Crits-Dighe, San Francisco, CA (US)

(21) Appl. No.: 18/990,877

(22) Filed: Dec. 20, 2024

(51) Int. Cl. G06F 16/9535; G06F 16/2457; G06F 16/9538

(52) U.S. Cl. CPC G06F 16/9535; G06F 16/24578; G06F 16/9538

(57) ABSTRACT

A technique is disclosed for presenting blocks (e.g., pages) that are considered relevant to a user of a workspace, where the pages that are chosen are determined based on the actions of other users whose actions closely align with the user's. Pairs of users in a workspace are given a similarity score based on how likely they are to be interested in the same content of the workspace. This can involve editing the same content, reacting to the same content, or other qualities that indicate a close association. Content is then presented to the user based on the actions of users while factoring in similarity scores.

### BACKGROUND

It is a common practice to enhance user engagement and content discoverability by providing a “most popular” section on websites. This section typically highlights the most frequently visited pages, offering users quick access to trending content. The implementation of such a feature relies on real-time analytics that monitor user interactions, including page views, clicks, and time spent on each page. By aggregating this data, the website can dynamically update the “most popular” section to reflect the current interests of its user base.

Traditionally, the “most popular” section operates by continuously monitoring user activity across the website. An analytics engine records each user visit, updating the popularity score of the visited webpage. This score is calculated using a weighted algorithm that considers various factors of the visits, such as the number of visits, the duration of each visit, and the recency of the visits. Web pages with higher scores are displayed more prominently, ensuring that content remains relevant and engaging for users.

### BRIEF DESCRIPTION OF THE DRAWINGS

Reference will now be made, by way of example, to the accompanying drawings which show example embodiments of the present application, and in which:

FIG. 1 is a block diagram illustrating a platform, according to examples of the present disclosure.

FIG. 2 is a block diagram of a transformer neural network, according to examples of the present disclosure.

FIG. 3 is a block diagram illustrating a hierarchical organization of pages in a workspace.

FIG. 4 is a block diagram that illustrates a database and a graphical user interface configured to present relevant content to a user of a workspace.

FIG. 5 is a flow diagram describing a method of presenting content that is relevant to a user of a workspace.

FIG. 6 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to techniques for presenting relevant content to a user of a workspace by analyzing the actions of other users whose behaviors most closely align with that of the user. This is done by evaluating user actions to produce similarity scores between the users, which are then used to determine relevant content that is presented to the user.

In a multi-user workspace, a group of users can collaborate closely, often interacting with the same pages, data, and members of the workspace. The group of users may not be confined to the workspace (e.g., they may not be formally part of a team in the workspace), and this group may change dynamically over time. If a particular user works closely with other users in a workspace, the pages that these other users frequently interact with will likely also be of interest to the particular user. Specifically, these pages are considered “relevant” to the particular user. Therefore, it could be beneficial to present a list of relevant pages to the particular user, as determined from the actions of other users whose activities closely align with those of the particular user. In some examples, data formats other than pages can also be deemed relevant in this way, such as documents, images, or, more generally, blocks in a block data model as described below.

In one example, a particular user of a workspace works on a document and collaborates with other users of the workspace. The other users may collaborate on the same document or on content outside of the document. The particular user can interact with the document often such that it would be useful to make the document accessible to certain users of the workspace and not others. In particular, the document (or the page containing the document) could be relevant to a user of the workspace that is similar to the particular user and not relevant to a user of the workspace that is dissimilar to the particular user. In another example, a new document that a particular user has not accessed before is created by another user of the workspace. If the other user is deemed similar to the particular user, the document is brought to the attention of the particular user. In contrast, if the other user is deemed dissimilar to the particular user, the new document is not brought to the attention of the particular user.

These techniques contrast with methods of suggesting most-viewed pages to a user, which are based solely on the total number of views. For instance, a newly created page could be of interest to a user despite having a limited number of total views, and thus should be considered relevant to the user. Conversely, a bulletin or announcement of a new page for an entire workspace may not necessarily be useful or something that a particular user would want to interact with regularly. Therefore, the new page should not be considered relevant to that user.

In one implementation, each pair of users in a workspace is assigned a similarity score based on how closely their interests align, which could be calculated based on how closely their actions align. The similarity score between users is designed to assess how likely it is that, for instance, the two users work closely together, work on the same projects, have a similar focus, or are on the same team. This can include actions that are identical between users such as when two users make edits on the same document but can also include other indications of what makes two users similar. In one example, users who work on the same documents, share files with each other, or message each other directly are likely to work on the same projects and be interested in the same pages. In another example, users who do not work on the same documents but comment on similar pages, download different files from the same page, or communicate with the same third user, may still be similar users who will be interested in similar pages.

The similarity score between users can be determined based on the content they interact with or their manner of interaction. For instance, the similarity score for two users who comment on the same page may differ from that of a user who comments and another who contributes to the page's content. Additional factors influencing the similarity score include the content of the pages visited by users, the volume, frequency, or rate of change in one user's mentions of another in messages and comments, the number, frequency, or rate of change in direct messages between users, the volume, frequency, or rate of change in users sharing the same pages with others, the volume, frequency, or rate of change in one user sharing another's pages or content, the extent to which one user invites another to a common page or task, and the roles users hold within a workspace, website, or organization such as a company.

In one implementation, multiple blocks (e.g., pages) of a workspace are each assigned a relevance score for a particular user, where the score is influenced by the similarity scores between the particular user and other users who interact with the pages. There are multiple ways that the relevance score could be calculated. A calculation can consider factors such as a weighted average of interactions by similar or dissimilar users, where the number of interactions by a user on a page is weighted by that user's similarity score with the particular user; a threshold in similarity score, where a user's interactions are not considered if their similarity score is not at or above a certain limit; a threshold in similar user interactions, where a page is not considered relevant unless it has been visited by enough users with a sufficiently high similarity score; or some combination of these and other factors. In some implementations, the similarity scores between users are calculated using an artificial intelligence (AI), including a machine learning (ML) model, which can consider factors listed above as well as additional factors.

The relevance score can be negatively impacted by certain aspects of a page that other users visit. For example, a page that has a sufficiently high number of views from a sufficiently large number of users, including those with high and low similarity scores, may indicate a company-wide announcement or bulletin and thus should have a low relevance score. Such a page may be suggested by other resources; for instance, by a list of most-popular pages that ignores user similarity or by a company bulletin board that lists announcement pages by date and time. The balance between positive and negative influences can be changed depending on the intent of the suggested pages (e.g., striking a balance between pages that the user will probably need to frequently access and pages that the user has not seen but would find interesting).

A set of blocks and users considered in certain implementations of the disclosed technology can be restricted based on privileges or roles of the users. For example, if the user is a member of multiple groups on the same workspace, similarity scores may only be assigned between members of a certain group based on actions taken on pages within that group, and relevance scores may only be assigned to pages within that group. Such a group may be considered a workspace within a workspace. In addition, relevance scores may be assigned to pages from multiple groups that the user is a part of, determined through the use of similarity scores between the user and users of those groups, and presented to the user as a single list of recommended pages.

Although often described herein as pages or documents, the objects users interact with could be referred to generally as blocks. Blocks are units of information that can include data, attributes, properties, and other blocks. Thus, workspace pages can be blocks containing content or other blocks. Relevance scores can be assigned to all workspace blocks, only page blocks, or other specific block types. References to “pages” suggested to users can refer to any workspace object, such as documents, images, spreadsheets, databases, or blocks of a block data model. Similarly, references to blocks can refer to pages or other objects in implementations outside the block data model.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

The disclosed technology may be implemented with a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks'content arrays is inefficient, especially on the client. Instead, the model uses an “upward pointer” the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the /aveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

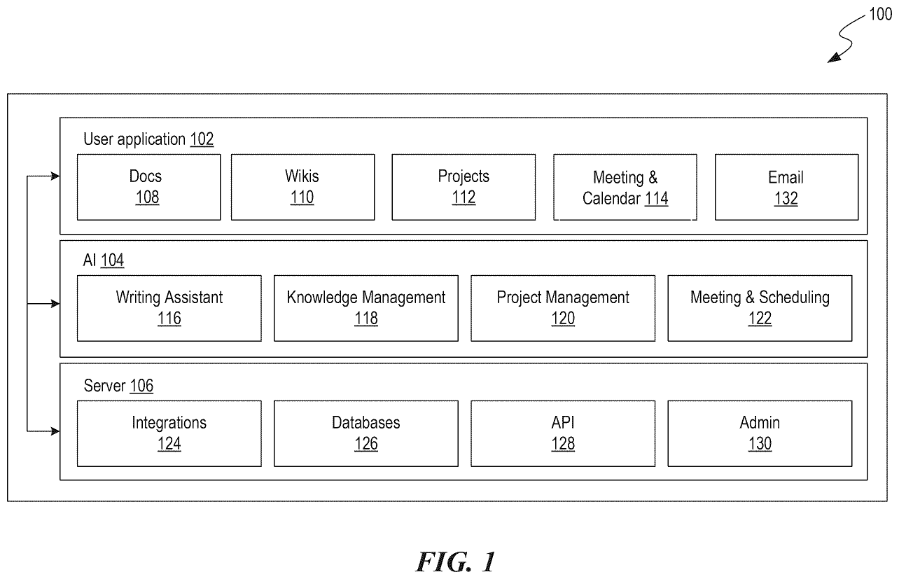

FIG. 1 is a block diagram of an example platform 100. The platform 100 provides users with an all-in-one workspace for data and project management. The platform 100 can include a user application 102, an AI tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading) or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and urgent information layout. Each view can include a customized structure including custom criteria, custom properties, and custom actions. The custom properties can be specific to a view such as artificial intelligence-extracted properties, and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the system 100 to another email address within the system 100, can include an embedding of a document within the system 100, or an embedding of a block in the document. In another example, a wiki can link to a meeting within the calendar.

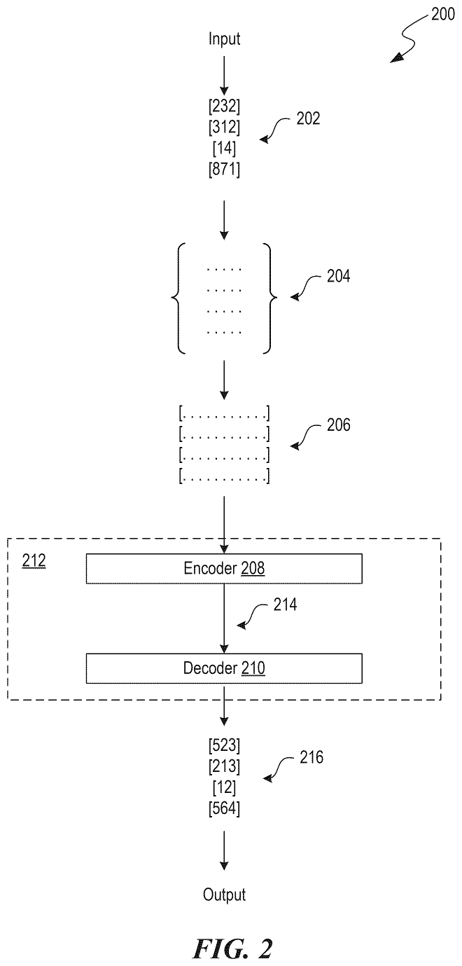

The AI tool 104 is an integrated AI assistant that enables AI-based functions for the user application 102. In one example, the AI tool 104 is based on a neural network architecture, such as the transformer 212 described in FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include auto filling information based on changes within the workspace or automatically track project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 200 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 2 is a block diagram of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

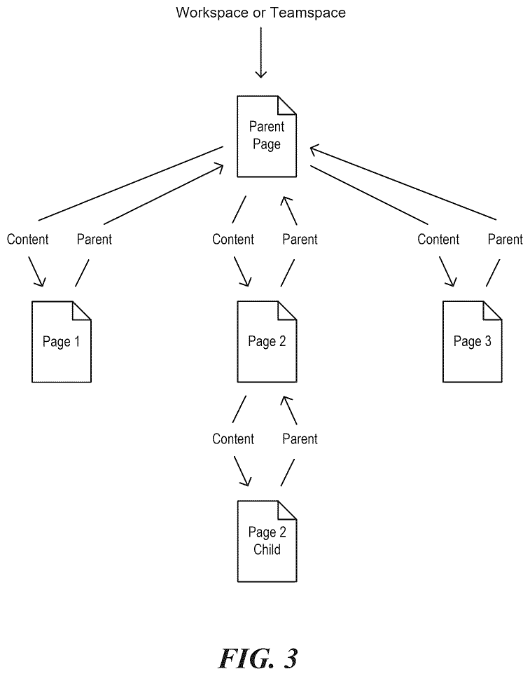

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Presentation of Relevant Blocks

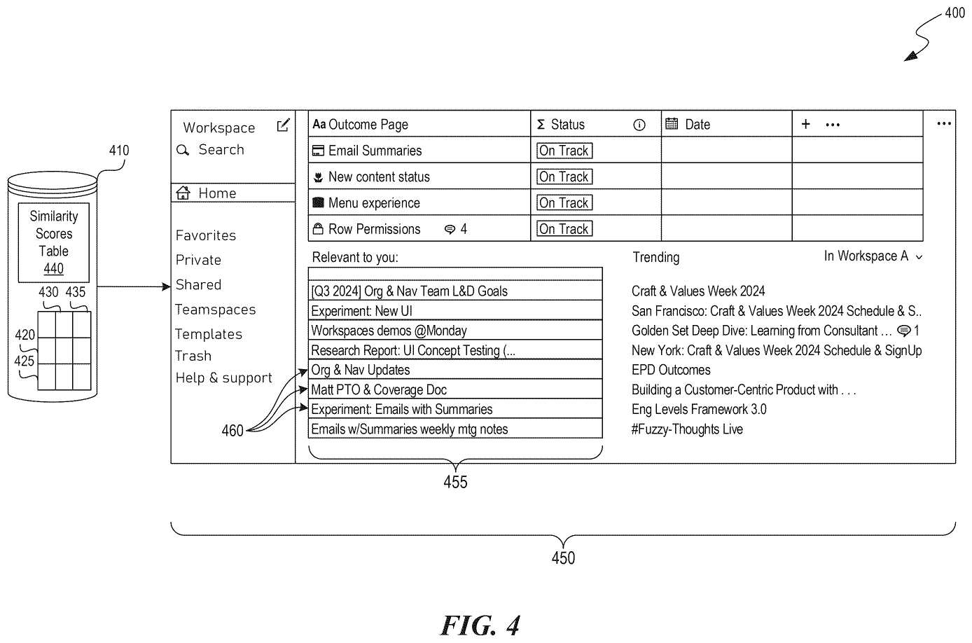

FIG. 4 illustrates an example embodiment of a system 400 in which aspects of the disclosed technology can be implemented. This embodiment includes an illustration of a database 410 that stores relevant data about the workspace and its users, and an illustration of a graphical user interface 450, such as a page, through which suggested blocks, such as pages, can be presented to the user on a computing device.

When a particular user accesses the graphical user interface 450 of the workspace, the particular user is presented with a suggestions block 455 containing a custom list of references 460 that identifies blocks of the workspace that are relevant to the particular user. This list can be presented dynamically and automatically upon a user accessing a particular page, such as a home page, or can be presented by request from the user. Each of the references 460 contain information identifying a block, and may include other features such as a link to access the referenced block, the name of one or more users that are associated with the referenced block (e.g., users that frequently interact with the referenced block), content of the block, or statistics about the block such as number of views or number of edits.

The suggestions block 455 is populated with references based on the data recorded in the database 410, which may correspond to a database 126. Database 410 records signals indicative of actions taken by users on blocks of the workspace. The actions taken on a block can include, for example, viewing a block, editing contents or properties of a block, moving a position of a block on the page, reacting to the block, commenting on the block, sharing the block with another user, or other such actions. These actions are illustrated as rows 420, 425, each representing an entry. Each entry can contain multiple components or signals that represent the data of each entry, illustrated as columns 430, 435. Such data can include the identity of the user performing the action, the identity of the block that was acted on, the owner or the original creator of the block that was acted on, the type of action, the details of the action (e.g., the text that was changed or other data defining the action), the time that the action occurred, the identity of the workspace, or any other relevant or contextual information about the action.

The entries 420, 425, are then used to calculate similarity scores of a set of users relative to a particular user of the workspace. When a particular user is fixed, this can be seen as a similarity score assigned to each of the set of other users relative to the particular user. This set may contain all other users in the workspace or be a restricted set of users. For example, if the particular user is a member of a group within the workspace, the set of users may be the set of users who are also members of the group. The similarity score of each user is calculated by a similarity score algorithm that is configured to measure how likely it is that the blocks the user interacts with are also blocks that the particular user will want to interact with. For example, if two users edit the same types of documents, comment on the similar pages, share information with each other, or have similar roles in the workspace, this may lead to a higher calculated similarity score. As a specific example for a particular second user, the similarity score algorithm may process all entries 420, 425, of the database 410 whose data components 430, 435, identify a particular block (such as a shared document) and further identify the particular user or the particular second user. The similarity score algorithm may take into consideration the types of actions associated with these entries (such as viewing, editing, or sharing the block). In some implementations, the similarity score algorithm uses AI/ML such as the transformer 212 described in FIG. 2 to generate similarity scores.

In some implementations, similarity scores are stored in the database 410 in a similarity scores table 440 or any other appropriate data storage format. The similarity scores are then used to calculate relevance scores for a set of blocks. This set of blocks may include all blocks of a workspace or a restricted set. For example, the set of blocks may only include the blocks of a specific group or set of groups that the particular user is a member of, only include blocks that the particular user has certain privileges to (e.g., to view, edit, comment on, and the like), or only include blocks of a specific type or set of types (e.g., pages, documents, images, and the like). Each relevance score is specific to a particular block and the particular user and is calculated using a relevance score algorithm intended to measure how likely it is that the particular user would like to access the particular block.

For example, a block that a first user and a second user, with a high similarity score relative to the first user, both edit frequently has a higher relevance score than a block that the first user and the second user both view or a block that the first user and a third user, with a lower similarity score, both edit. As a specific example for a particular block, the relevance score algorithm may process entries 420, 425 of the database 410 whose data components 430, 435 identify the particular block and further processes the similarity scores of the users identified in those entries. The relevance score algorithm may take into consideration the types of actions associated with these entries (such as viewing, editing, or sharing a block). The relevant blocks are not necessarily new to a user. For example, a block that is unknown (e.g., new) to the user could be less relevant to the user than a block that is already known to the user.

A relevance score may be determined based on various signals, in addition to actions performed on blocks. For instance, search queries entered by the user and related interactions with search results could impact the relevance score of blocks. If the user's recent search history includes a query on a specific topic that returned certain blocks, then the relevance score for those blocks, or blocks with similar or related content or attributes, can be elevated. For example, if the user recently searched for information about a team project, the relevance score of blocks containing content pertinent to the team project, accessed by users with a sufficiently high similarity score, will be increased relative to blocks lacking such content or relative to blocks with content pertinent to the team project but accessed by dissimilar users.

A suggestions block 455 is then populated with references 460 (eight shown in FIG. 4) which each reference a relevant block of the workspace. The relevance scores of the blocks are used to determine which blocks are referenced in the suggestions block 455. For example, the suggestions block 455 can be populated with references to the blocks that have the highest relevance scores. Furthermore, the number of references may be determined by a property of the particular block. For example, the number of references can be determined by the size of the particular block when presented in the graphical user interface 450 or can be determined by a maximum or minimum number associated with the particular block that is set by a user. These references 460 can additionally include relevant information about the block, for example, the name of the block, an excerpt of the content of the block, how many users have acted on the block, or the name of a user with a high similarity score that has interacted with the block. The references 460 may also include a way to access the referenced block, such as a hyperlink to the block or a page containing the block. The suggestions block 455 containing the references 460 is then displayed on the graphical user interface 450.

In some implementations, a relevance score algorithm employs a generative AI model and/or neural network, such as the transformer 212 illustrated in FIG. 2, to generate content displayed in the suggestions block 455. For instance, signals input to an LLM can indicate recent activities of a user, calendar entries, messages exchanged with team members, or other signal sources indicative of blocks that are timely or contextual and likely to be accessed by the user, which are presented as suggested blocks.

In one example, the blocks, their content, or associated metadata (e.g., properties) are processed by an LLM as inputs to produce snippets of the blocks. These snippets can comprise generative content, such as summaries, images, or descriptions of the blocks. Consequently, the references of the blocks presented in the suggestions block 455 include AI-generated content, potentially offering greater utility for the user in understanding the relevant block's content compared to merely presenting a title as the reference to the relevant block.

Additionally, data employed to generate similarity and/or relevance scores can be utilized by an LLM to create a description of a block, indicating why the block is relevant to the user. For example, an AI system can use signals from the user's calendar to ascertain that pages related to a particular project are pertinent due to an upcoming meeting on that project later the same week. Thus, the suggestions block 455 can include references to blocks pertinent to the project, with these references including summaries and/or indications of why the blocks are considered relevant to the user.

### Relevance Score-based Suggestions

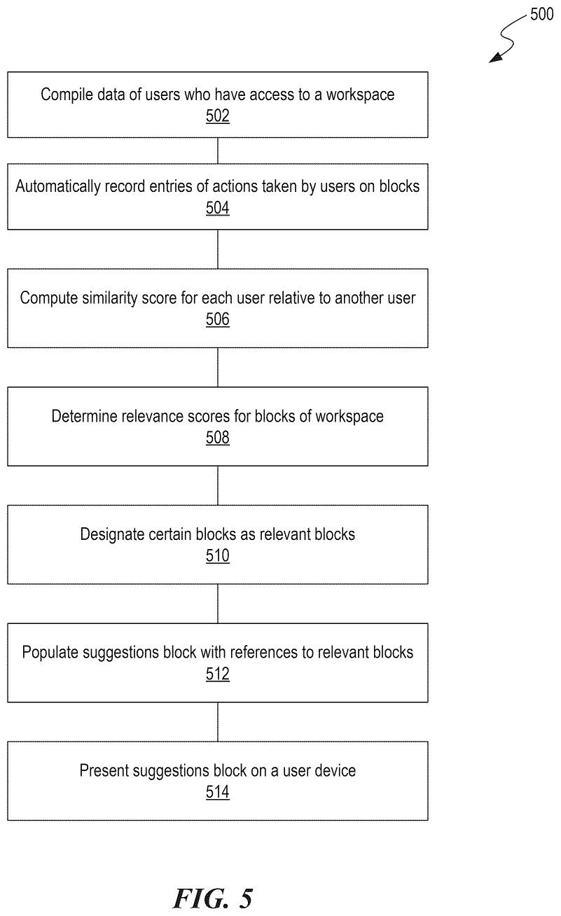

FIG. 5 is a flow diagram 500 that illustrates a method for a system to present a suggestions block to a particular user, populated with references to relevant blocks of a workspace. As previously mentioned, a collaborative, multi-user workspace includes a collection of digital data that can be accessed and modified by multiple users. Online workspaces can display a graphical representation of data to users, often through a web browser interface. Workspaces may have user profiles that store information and permissions associated with each user. If the workspace contains nested workspaces, such as groups, team spaces, or teams of users within the workspace, the user information can specify the user's memberships and permissions within those areas.

A workspace can include data objects such as pages, images, documents, spreadsheets, user information, and/or blocks of a block model as previously above. The actions that users can take on these objects can include creating, uploading, viewing, commenting on, sharing, downloading, or deleting objects, as well as modifying an object's properties such as format, color, size, or position in a graphical representation of the workspace. Implementations that do not use the block model as described above can use other data objects, such as those described above, in a corresponding way to achieve similar results. In some implementations, a workspace contains blocks and/or non-block objects, and any such object can be suggested to a particular user in accordance with the present disclosure.

At 502, the system compiles data of a set of users who share a workspace with the particular user. This system may be identical to the system that stores and/or processes data of the workspace or may be distinct. The set of users can contain all users of the workspace, or it can be a restricted set of users. The users in the set of users may be chosen based on criteria, such as membership in certain groups or workspaces of the workspace. For example, a set of users may be all users that share a workspace with the particular user, such a workspace possibly being an object contained in a larger workspace. In another example, the set of users may be chosen based on the role or title of users within a workspace. Some implementations can contain aspects of multiple such approaches, such as choosing users of certain roles in certain workspaces.

At 504, the system automatically records, in a database, entries including signals such as a log of actions performed by the set of users on blocks of the workspace. These can be recorded, for instance, in response to an action occurring. In one example, each entry of the database includes data identifying a user performing an action, a target block that an action is performed on, and a type of action performed on the target block. Each entry could contain more data or signals, such as a time and/or date, the contents of the action (such as the text inserted into a document), or a user who owns the target block.

The types of actions performed on a block that can be recorded include, but are not limited to, creating a block, viewing a block, modifying content of a block, modifying properties of a block, adding comments to a block, reacting to a block, sharing a block with a user, giving ownership of a block to a user, giving permissions for a block to a user, receiving ownership of a block, receiving permissions for a block, or downloading a block. Viewing a particular block can include indirectly viewing the particular block by viewing a block that contains the particular block. Modifying content of a block can include changing the title, description, or contents of the block.

The contents of a block can include text, image data, formatting data, video data, spreadsheet data, and other such document-type data. Modifying the properties of a block can include giving or receiving ownership of a block or permissions for a block, changing the workspace a block is part of, changing size or shape of a graphical representation of a block, changing a type of block, or changing the format or display parameters of a block. Adding comments to a block can include adding standalone comments pertaining to the block, adding response comments in a comment thread, or adding comments pertaining to the contents of the block such as a comment directed to a particular sentence in a document. Reacting to a block can include liking, disliking, rating, recommending, or sharing the block or its content with users. Sharing a block with a user can include sharing a block or its content directly with another user (such as through a direct message) or sharing a block or its contents generally with an audience (such as through a post or general recommendation on a user profile).

The types of actions and examples of actions listed here should not be construed as limiting, and other actions can be considered. In some implementations, blocks are presented with an option to perform one or more of these actions. For example, the graphical representation of a block presented to a user may include buttons to perform actions such as liking, sharing, commenting, or other such actions.

At 506, the system computes a similarity score for each user of the set of users relative to a particular user. A similarity score is associated with a pair of users, and can be considered to be associated with a single user when one user of the pair is fixed, such as when assigning similarity scores between users and a particular user of a workspace, the particular user being fixed. The similarity score associated with a pair of users, namely a user and the particular user, is determined based on signals including the similarity of actions that users perform on the workspace. In some implementations, calculating a similarity score for a user involves analyzing the actions taken by the user and the particular user on a common block. In some implementations, calculating the similarity score for a user includes processing a set of entries in the database that share a common block, that is, each entry of the set of entries identifies a target block that is identified by each entry in the set of entries and identifies the user or the particular user. In some implementations, the similarity score is affected by actions taken directly towards other users, such as direct messaging between users.

In some implementations, computing a similarity score for a user may involve processing actions, possibly stored as entries of a database, using an AI/ML system. For example, actions made by either the user or the particular user on a common block may be processed using an AI model. In another example, a set of entries of the database may be processed using an AI model, where each entry of the set of entries identifies the particular user or a user of the set of users and identifies a target block that is common to each entry in the set of entries.

At 508, the system determines a relevance score for each of a set of blocks of the workspace. The set of blocks can contain all or fewer blocks of the workspace. The blocks in the set of blocks may be chosen based on some criteria, such as the block being available to members of certain groups or workspaces of the workspace. For example, the set of blocks may be all blocks of one or more workspaces of the particular user, such workspaces possibly being objects contained in larger workspaces (e.g., nested workspaces). In another example, the set of blocks may be chosen based on a property of the blocks, such as block type, date created or last modified, the user who created the block, or a level of permission of a particular user with a block. Some implementations contain aspects of multiple such approaches, such as choosing blocks from certain workspaces of a certain type that the particular user has permission to edit.

The relevance score of a block is determined, at least in part, through an analysis of user actions performed on the block, while also considering the similarity scores of those users. For instance, the system may calculate a relevance score for a block by evaluating the actions taken on it by users, as well as the similarity scores of the individuals performing these actions. Additionally, the system can calculate the relevance score of a block by examining actions carried out on the block by users whose similarity scores exceed a predefined threshold. This process involves analyzing database entries that identify both the block and the users with similarity scores at or above the predefined threshold.

There are several methods for calculating the relevance score based on this data. One approach could involve summing the number of actions by users with a similarity score that exceeds a certain threshold value. Alternatively, the relevance score could be determined by a weighted average of various user actions, adjusted according to their similarity scores. For instance, a frequency of actions taken by a user could be multiplied by the user's similarity score, and the results averaged across all users. Additionally, actions can be assigned different weights depending on their type. For example, views might be assigned a weight of 0 and therefore excluded from consideration, whereas edits could be assigned a weight of 2, thus having a greater impact on the similarity score than other actions.

In one approach, calculating a relevance score for a block involves determining a weighted average of several actions, where each action is performed by a user with a similarity score, and each number of actions is weighted according to this similarity score. Alternatively, computing a relevance score for a block can involve calculating a weighted average of several database entries that identify both a user and the block, with each entry being weighted based on the similarity score of the identified user. Moreover, in another example, the relevance score for a block can be determined by considering factors such as the recency, frequency, or changes in frequency of modifications or additions made to a block, including recent comments. Consequently, blocks with frequent or increased activity will have a higher relevance score compared to those with a greater number of comments but less recent activity.

In some implementations, determining the relevance score of a block may involve processing data using an AI/ML model. For example, actions, possibly stored as entries in a database, taken on the block by users with a calculated similarity score can be processed using an AI model. In another example, determining a relevance score for a block includes processing a set of entries of the database using an AI/ML model, where each entry in the set of entries identifies the block and a user with a similarity score, which may further be a similarity score exceeding a threshold value.

At 510, the system designates certain blocks from the set of blocks of the workspace as relevant blocks. Designating a block as a relevant block involves analyzing the relevance score of the block. In some implementations, the relevant blocks are those blocks with relatively high relevance scores and that will potentially be presented to the particular user. For example, each block designated as a relevant block may have a relevance score that is greater than or equal to the relevance score of any block that is not designated as a relevant block.

In some implementations, the system may determine a specific number of blocks to designate as relevant blocks. This may be influenced by, for example, the space available on a page for displaying information about relevant blocks. In some implementations, the system determines a number of blocks to designate as relevant blocks, where the number is based at least in part by a property of a particular block that will be populated with references to relevant blocks. The property used to determine the number of relevant blocks can include a size of a graphical object that depicts the particular block, or could be a property directly input by a user such as a maximum number of references to display, among other possibilities. The disclosed technology is not limited by the need to explicitly designate certain blocks as relevant blocks, as described in more detail later.

In one implementation, a technique for determining the relevance score of a block involves processing search queries or related search results associated with a specific user to generate a property for the suggested blocks. As such, the suggested blocks have the property. Another approach involves utilizing AI (e.g., LLMs) to process signals associated with the particular user, thereby generating a property for the suggested blocks. Examples of signals include indications of contextual information or recent activities of the user within the workspace.

At 512, the system populates a particular block (e.g., a suggestions block) with references to relevant blocks. This involves adding or modifying data of the particular block so that the data contains the references. Each reference identifies a single specific relevant block. In some implementations, the particular block is populated with references to blocks, which identify blocks that are chosen based at least in part on the relevance scores of each of a set of blocks in the workspace. This can be the set of blocks that are assigned relevance scores at 508. These blocks can additionally be chosen based at least in part on a property or constraint of the particular block, such as the size of a graphical object that represents the particular block. In such an implementation, the system may not need to designate certain blocks as relevant blocks. It should be appreciated that such an embodiment may still perform operation 514, with descriptions pertaining to relevant blocks being replaced by blocks that are identified by references in the particular block.

At 514, the system causes presentation of a populated particular block on a user interface of a user device. This may involve a presentation of a graphical object representing the particular block and/or its contents. In some implementations, each reference to a relevant block is displayed as a graphical object that includes information pertaining to the relevant block identified by the reference. The information pertaining to the relevant block can include information such as title, description, type, contents, summary of contents, number of views, relevance score, size, user(s) that created the block, user(s) who have acted on the block, time of creation, time of last modification, a workspace containing the block, among other information, or combinations thereof.

In one example, each reference is displayed as a graphical object that includes the identity of a user who has performed an action on the relevant block. This can be a user with a high similarity score, meaning a user to whom a high similarity score has been assigned based on their similarity to the particular user accessing the particular block. In some implementations, the system can present, in association with each reference to a relevant block, a hyperlink to the relevant block identified by the reference. This may take the form of a clickable graphical object that directs a user to the relevant block identified by the reference. A hyperlink associated with a relevant block can route a user directly to the relevant block if it is a page, or route the user to a block containing the relevant block if it is a comment or document contained within a page.

In one example, the system uses an LLM to process content of a relevant block or a relevance score of the relevant block to generate a description for the relevant block. The description can include a summary of the content or an explanation of a relevance of the relevant block to the particular user. As such, the reference to the relevant block can include the description.

### Computer System

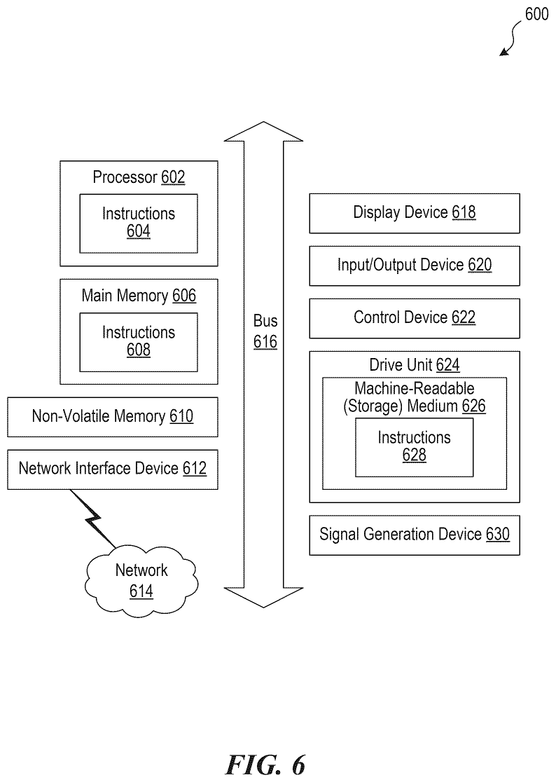

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a display device 618, an input/output device 620, a control device 622 (e.g., keyboard and pointing device), a drive unit 624 that includes a machine readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computer system 600 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 600. In some implementations, the computer system 600 can be an embedded computer system, a system-on-chip (SOC), a single-board computer (SBC) system, or a distributed system such as a mesh of computer systems or include one or more cloud components in one or more networks. Where appropriate, one or more computer systems 600 can perform operations in real time, near real time, or in batch mode.

The network interface device 612 enables the computer system 600 to mediate data in a network 614 with an entity that is external to the computer system 600 through any communication protocol supported by the computer system 600 and the external entity. Examples of the network interface device 612 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computer system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computer system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A computer-implemented method of presenting references to one or more blocks of a workspace that are relevant to a particular user of the workspace, the method comprising:
automatically recording, in a database, entries that log actions performed on blocks of the workspace by users of the workspace,
wherein each entry includes data identifying a user who performed an action, a block on which the action was performed, and a type of action performed on the block, and
wherein the type of action includes creating the block, viewing the block, modifying content of the block, or sharing the block with another user of the workspace;
computing a similarity score for respective users of the workspace relative to the particular user based on a set of entries in the database that include blocks in common with the particular user;
determining a relevance score for each block of one or more blocks based on actions performed on the one or more blocks by users of the workspace having a predetermined similarity score;
designating a particular block of the one or more blocks having a predetermined relevance score as a relevant block for the particular user; and
causing presentation, on a user device, of a reference to the relevant block in an area of a user interface that includes relevant blocks as suggested blocks for the particular user of the workspace.

2. The computer-implemented method of claim 1, wherein causing presentation of the reference of the relevant block on the user interface further comprises:
causing presentation, in association with the reference to the relevant block, of a hyperlink to the relevant block identified by the reference.

3. The computer-implemented method of claim 1, wherein causing presentation of the reference of the relevant block on the user interface further comprises:
causing presentation, in association with the reference to the relevant block, of information including an identity of a user of the workspace who has performed an action on the relevant block.

4. The computer-implemented method of claim 1, wherein determining the relevance score for each block of the one or more blocks further comprises:
processing search queries or related search results associated with the particular user to generate a feature any relevant block; and
wherein the suggested blocks each include the feature.

5. The computer-implemented method of claim 1, wherein determining the relevance score for each block of the one or more blocks further comprises:
processing, using a large language model (LLM), signals associated with the particular user to generate a feature for any relevant block,
wherein the signals include contextual information of the particular user or recent activities of the particular user in the workspace.

6. The computer-implemented method of claim 1 further comprising, prior to causing presentation of the reference on the user interface:
processing, using a large language model (LLM), content of the relevant block or the relevance score of the relevant block to generate a description for the relevant block including a summary of the content or an explanation of a relevance to the particular user,
wherein the reference to the relevant block includes the description.

7. The computer-implemented method of claim 1, wherein determining the relevance score for each block of one or more blocks further comprises:
calculating a weighted average for a number of entries identifying a user and a block on which the user performed an action,
wherein each of the number of entries is weighted by the similarity score of the user identified by the entries.

8. The computer-implemented method of claim 1, wherein the area of the user interface is defined by a block configured to present the suggested blocks, the method further comprising:
determining relevant blocks based on a property or constraint of the block that includes the suggested blocks.

9. The computer-implemented method of claim 8, wherein the property or constraint of the block includes a size of a graphical object depicting the block.

10. A system comprising:
at least one hardware processor; and
at least one non-transitory memory storing instructions, which, when executed by the at least one hardware processor, cause the system to:
compile data of a set of users who are authorized to access a workspace,
wherein the set of users includes a particular user;
record entries in a database, each including data identifying a user, a block, and a type of action performed on the block by the user;
compute a similarity score for each user of the set of users relative to the particular user based on entries in the database that have blocks with the user and the particular user in common;
determine a relevance score for each block of a set of blocks of the workspace based on entries that include the block and identify a user with a threshold similarity score;
populate a graphical object with references to blocks that satisfy a threshold relevance score; and
cause presentation, on a user device, of the populated graphical object.

11. The system of claim 10, wherein each reference to a block is displayed as a graphical object that includes a hyperlink to the block identified by the reference.

12. The system of claim 10 further caused to, prior to presentation of the populated graphical object:
process, using an artificial intelligence (AI) system, a relevance score or content of a block that satisfies the threshold relevance score to generate a summary of the content or an explanation of a relevance to the particular user,
wherein a reference to the block includes at least an indication of the summary of the content or the explanation of a relevance to the particular user.

13. The system of claim 10, wherein to determine the relevance score for each block of a set of blocks further comprises causing the system to:
calculate a weighted average of a number of actions taken on the block,
wherein actions performed by a user on the block are weighted by the similarity score of the user.

14. The system of claim 10, wherein references identify blocks that are chosen based at least in part on a property of the graphical object.

15. A non-transitory, computer-readable storage medium comprising instructions recorded thereon, wherein the instructions, when executed by at least one data processor of a system, cause the system to:
compute a similarity score for each of a set of users who are authorized to access a workspace,
wherein to compute a similarity score for a user involves analyzing actions taken by the user and other users on blocks;
compute a relevance score for each block of a set of blocks of the workspace,
wherein to compute the relevance score for the block involves analyzing actions taken on the block and analyzing the similarity scores of users taking the actions on the block;
designate certain blocks of the set of blocks of the workspace as relevant blocks,
wherein designating a block as a relevant block involves analyzing the relevance score of the block; and
cause a presentation, on a user device, of a particular block,
wherein the particular block includes references to the relevant blocks, each reference identifying a respective relevant block and being displayed as a graphical object including information pertaining to the relevant block identified by the reference.

16. The non-transitory, computer-readable storage medium of claim 15, wherein each reference is displayed as a graphical object that includes a hyperlink to a relevant block identified by the reference.

17. The non-transitory, computer-readable storage medium of claim 15, wherein computing the similarity score for the user further comprises causing the system to:
process actions using an AI model, each action being taken on a common block, each action being caused by either the user or the particular user.

18. The non-transitory, computer-readable storage medium of claim 15, wherein to compute the relevance score for each block of the set of blocks further comprises causing the system to:
process, using a large language model (LLM), signals associated with the particular user to generate a property for the relevant blocks,
wherein the signals include contextual information or recent activities in the workspace by the particular user.

19. The non-transitory, computer-readable storage medium of claim 15, wherein computing the relevance score for each block of a set of blocks further comprises causing the system to:
calculate a weighted average of a number of actions taken on the block, each action being caused by a user that has a particular similarity score, each number of actions being weighted by the particular similarity score.

20. The non-transitory, computer-readable storage medium of claim 15, wherein to designate certain blocks of the set of blocks as relevant blocks further comprises causing the system to:
determine a number of blocks to designate as relevant blocks based on a property of the particular block that includes references to the relevant blocks.
